(19) United States
(12) Patent Application Publication
(10) Pub. No.: US 2023/0162741 A1
(43) Pub. Date: May 25, 2023

(54) VOICE VERIFICATION AND RESTRICTION METHOD OF VOICE TERMINAL

(71) Applicant: Jong Yup LEE, Seoul (KR)

(72) Inventor: Jong Yup LEE, Seoul (KR)

(21) Appl. No.: 18/152,101

(22) Filed: Jan. 9, 2023

Related U.S. Application Data
(63) Continuation-in-part of application No. PCT/KR2021/009479, filed on Jul. 22, 2021.

(30) Foreign Application Priority Data
Jul. 24, 2020 (KR) 10-2020-0092470

(51) Int. Cl. G10L 17/22; G10L 25/63; G08B 25/00; G10L 17/18

(52) U.S. Cl. CPC G10L 17/22; G10L 25/63; G08B 25/00; G10L 17/18

(57) ABSTRACT

A voice verification and restriction method of the voice terminal includes: a) voice storage step including: inputting and registering voice of a user through a microphone of the voice terminal, receiving and analyzing the input voice using a language processing module, transmitting the analyzed voice to a plurality of voice authentication servers to verify and store each voice, and learning the stored voice using an AI processor; and b) voice verification step including: mutually comparing the input voice with voice stored in at least one server among voices stored in the plurality of voice authentication servers, performing approval and a voice command when the input voice matches the stored voice, and setting restrictions on all or some of functions of the voice terminal and executing a step-by-step action designated by the user when the input voice does not match the stored voice.

### BACKGROUND OF THE INVENTION

### Field of the Invention

The present invention relates to a voice verification and restriction method, and more particularly to a voice verification and restriction method of a voice terminal for preventing unauthorized use by others and leakage of personal information.

### Description of the Related Art

Conventionally, when a user gives a voice command to obtain desired information (data, content, news, information, etc.) from information (in the form of text, characters, an image, or voice) provided through a wired/wireless communication network (including the Internet) using artificial intelligence (AI) voice technology, specific information is extracted from a database incorporated in products or collected from external information providing portals (including portal companies such as Google, Amazon, Apple, YouTube, Naver, and Daum, and other information providing sites or platforms such as Internet newspapers) through wired/wireless communication networks by the products through a product, etc. equipped with a microphone, a voice recognition device, and a speaker, and the information is provided to the user only using machine voice previously stored in the product.

Such an AI voice technology service has evolved to enable various tasks such as retrieving current weather information, music information, news, latest traffic conditions, and simple product and service orders.

Among products using conventional AI voice technology, a product equipped with a microphone, a voice recognition device, and a speaker is also referred to as “smart speaker”, which provides an AI voice information service while broadening an application range thereof in a mobile or portable form or a stationary form, and more specifically, to various mobile terminals such as vehicles, ships, and airplanes in addition to mobile phones, notebooks, tablet computers, computers, headsets, earphones, Bluetooth devices, speakers, and Internet of Things (IoT) products.

Currently, in a voice input scheme, a situation where there is no screen (screen part), that is, “Zero UI”, is gradually expanding a range thereof. Zero UI, first used by designer Andy Goodman, is receiving widespread attention as a term representing a new platform combining voice recognition technology and AI.

In the case of the news service market, supply of voice devices has been expanding since 2017, and not only overseas IT companies and domestic telecommunication companies such as SK Telecom and KT, but also Naver and Kakao are attempting to provide news provision services using voice services through launch and distribution of AI speakers.

Meanwhile, in general, conventional voice service technology receives voice information from a user, stores the voice information in a voice authentication server, and then simply compares voice of the user stored in the voice authentication server with voice input from a terminal, thereby authenticating the user.

However, this conventional voice service technology has a problem in that it is not possible to effectively address the loss or theft of the terminal even when all or some of functions of the terminal are set to be locked to prevent unauthorized use by others and leakage of personal information.

In addition, there is a problem in that voice of the user cannot be accurately and safely recognized or verified by simply comparing voice of the user stored in one voice authentication server.
(Patent Document 0001) Republic of Korea Patent Publication No. 2017-0049317

### SUMMARY OF THE INVENTION

Therefore, the present invention has been made in view of the above problems, and it is an object of the present invention to provide a voice verification and restriction method of a voice terminal for effectively addressing loss or theft of a terminal by executing a step-by-step response action designated by a user after setting restrictions for all or some of functions of the terminal in order to prevent unauthorized use by others and leakage of personal information.

It is another object of the present invention to provide a voice verification and restriction method of a voice terminal capable of accurately and safely recognizing and verifying voice of a user by storing voice of the user in a plurality of authentication servers to mutually compare and verify the voice and by storing user voice for each emotional state using a language processing module.

Problems to be solved by the present invention are not limited to the problems mentioned above, and other problems not mentioned will be clearly understood by those skilled in the art from the following description.

In accordance with the present invention, the above and other objects can be accomplished by the provision of a voice verification and restriction method of a voice terminal, the voice verification and restriction method including a) voice storage step and b) voice verification step, in which the a) voice storage step includes inputting and registering voice of a user through a microphone of the voice terminal, receiving and analyzing the input voice using a language processing module, transmitting the analyzed voice to a plurality of voice authentication servers to store each voice, and learning the stored voice using an AI processor, the b) voice verification step includes mutually comparing the input voice with voice stored in at least one server among voices stored in the plurality of voice authentication servers, performing approval and a voice command when the input voice matches the stored voice, and a function lock setting step of setting restrictions on all or some of functions of the voice terminal and executing a step-by-step action designated by the user when the input voice does not match the stored voice, when one or more users are preset, and a specific user gives a command through voice input, voices of users stored in the voice authentication servers are checked, and when the preset user matches, a name of the user is called and the command is executed, or the command is executed after a procedure of checking the user, and when the user does not match, a comment about a fact that the user does not match is made, or an operation returns to an initial stage again after a procedure of confirming that the user does not match, and when the voice of the user is not set, a command according to the voice of the user is executed without a separate voice authentication procedure.

The inputting and registering of the voice of the user may include designating and selecting a specific user and inputting and registering the specific user.

The analyzing of the voice using the language processing module may include classifying the voice of the user according to pronunciation, speed, respiration, rhythm, and vocal features and storing the voice for each emotional state.

In the function lock setting step of the voice terminal, after initial lock setting for all or some of the functions of the terminal, when voice is repeatedly mismatched upon re-entry, the user may execute a step-by-step response action designated in advance, and in step 1, an authentication message may be transmitted to a user terminal, in step 2, a warning message may be transmitted to a terminal set in advance by the user, and in step 3, a location tracking or emergency notification message may be transmitted to a mobile operator or a police station.

The voice terminal may have a mobile or portable form or a stationary form and more specifically may be applied to any one terminal among vehicles, ships, and airplanes in addition to mobile phones, notebooks, tablet computers, computers, headsets, earphones, Bluetooth devices, speakers, and IoT products.

The a) voice storage step and the b) voice verification step include selecting one or more languages such as Korean, English, Japanese, and Chinese.

Other features and more specific details of the present invention are incorporated into the detailed description and drawings.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a control block diagram illustrating a voice verification and restriction method of a voice terminal according to an embodiment of the present invention, and is a diagram illustrating a voice storage procedure;

FIG. 2 is a control block diagram illustrating the voice verification and restriction method of the voice terminal according to the embodiment of the present invention, and is a diagram illustrating a voice verification procedure;

FIGS. 3 and 4 are diagrams illustrating examples of use of the voice verification and restriction method of the voice terminal according to an embodiment of the present invention; and

FIG. 5 is a control block diagram illustrating a command processing step through a voice input by a specific user when one or more users are preset according to an embodiment of the present invention.

### DETAILED DESCRIPTION OF THE INVENTION

Since the present invention may have various changes and may have various embodiments, specific embodiments are illustrated in the drawings and described in detail in the detailed description. However, this is not intended to limit the present invention to a specific embodiment, and it should be understood to include all modifications, equivalents, or substitutes included in the spirit and technical scope of the present invention. In describing each figure, like reference numerals have been used for like elements.

Although “first”, “second”, etc. are used to describe various elements, these elements are not limited by these terms. These terms are merely used to distinguish one element from another. For example, without departing from the scope of the present invention, a first element may be referred to as a second element, and similarly, the second element may be referred to as the first element. The term “and/or” includes a combination of a plurality of related listed items or any one of the plurality of related listed items.

When an element is referred to as being “coupled” or “connected” to another element, the element may be directly coupled or connected to the other element. However, it should be understood that another element may be present therebetween. In contrast, when an element is referred to as being “directly coupled” or “directly connected” to another element, it should be understood that there are no other elements in the middle.

The terms used in this application are used only to describe specific embodiments, and are not intended to limit the present invention. A singular expression includes the plural form unless the context clearly dictates otherwise. In the present specification, it should be understood that a term such as “include” or “have” is intended to designate that the features, numbers, steps, operations, elements, parts, or combinations thereof described in the specification are present, and does not preclude the possibility of addition or presence of one or more other features, numbers, steps, operations, elements, parts, or combinations thereof.

The present invention may have various modifications and various embodiments, and a specific embodiment among the embodiments will be described in more detail through the detailed description and illustration of the drawings. In addition, in the description of the present invention, when it is determined that a detailed description of related commonly used technology may obscure the gist of the present invention, the description thereof will be omitted.

Hereinafter, preferred embodiments of the present invention will be described in detail with reference to the accompanying drawings.

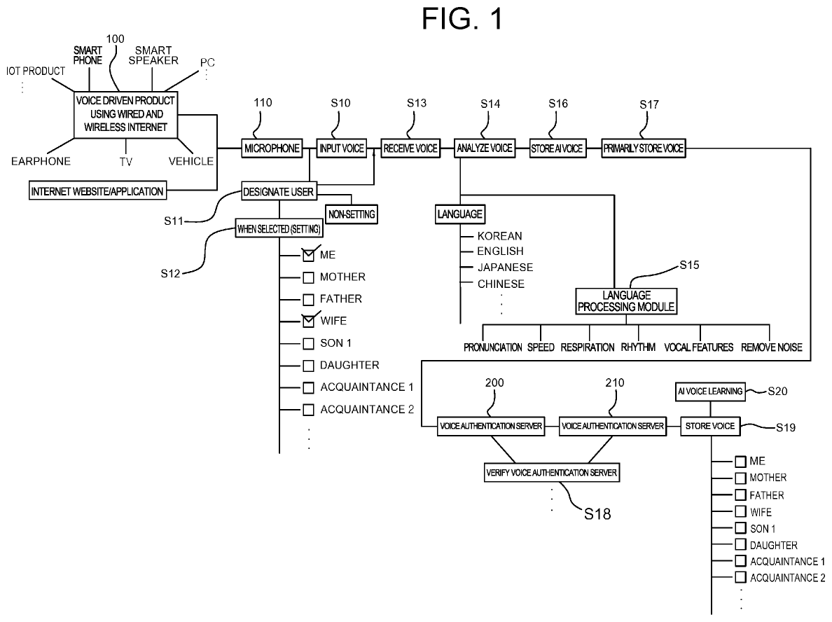

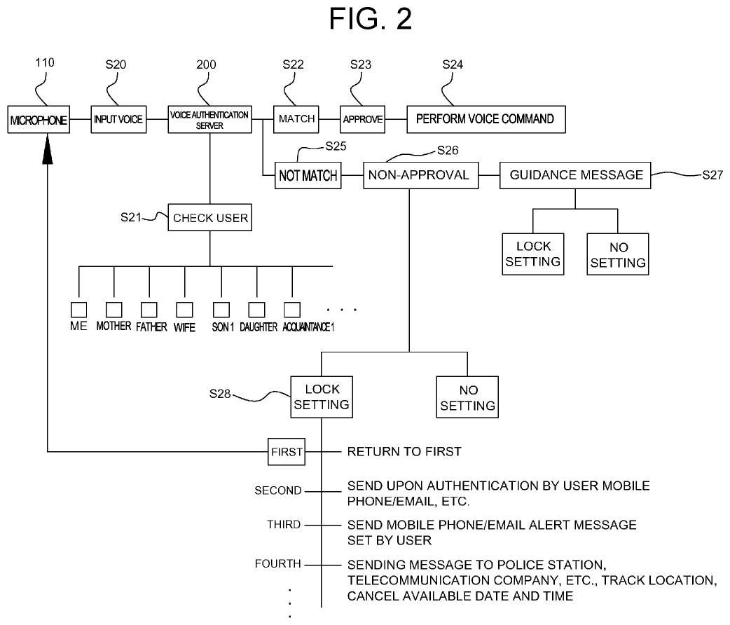

FIG. 1 is a control block diagram illustrating a voice verification and restriction method of a voice terminal according to an embodiment of the present invention, and is a diagram illustrating a voice storage procedure, and FIG. 2 is a control block diagram illustrating the voice verification and restriction method of the voice terminal according to the embodiment of the present invention, and is a diagram illustrating a voice verification procedure.

The illustrated figures are control block diagrams illustrating the voice verification and restriction method of the voice terminal according to the embodiment of the present invention, and include a) voice storage step and b) voice verification step.

First, as illustrated in FIG. 1, this figure is the control block diagram illustrating the voice verification and restriction method of the voice terminal according to the embodiment of the present invention. The voice storage procedure will be examined as follows. The a) voice storage step includes steps S10 to S12 of inputting and registering voice of a user through a microphone 110 of the voice terminal 100, steps S13 to S16 of receiving and analyzing the input voice using a language processing module, steps S17 to S19 of transmitting the analyzed voice to a plurality of voice authentication servers 200 and 210 to verify and store each voice, and step S20 of learning the stored voice using an AI processor.

In steps S10 to S12 of inputting and registering the voice of the user, it is preferable to input and register by designating and selecting a specific user. For example, a specific user such as the user, mother, father, son, daughter, or acquaintance may be designated and selected as the user.

In addition, in steps S13 to S16 of analyzing the voice using the language processing module, it is more preferable to classify the voice of the user according to pronunciation, speed, respiration, rhythm, and vocal features, determine each emotional state, and store and analyze the voice for each emotional state.

In addition, as illustrated in FIG. 2, this figure is the control block diagram illustrating the voice verification and restriction method of the voice terminal according to the embodiment of the present invention. The b) voice verification step includes step S21 of mutually comparing the voice input in the step a) with voice stored in at least one server among voices stored in the plurality of voice authentication servers 200 and 210 and verifying the voice, steps S22 to S24 of performing approval and a voice command when the input voice matches the stored voice, and a step of setting restrictions on all or some of functions of the voice terminal and executing a step-by-step action designated by the user when the input voice does not match the stored voice.

In this case, a specific guidance message according to non-approval may be output, and a setting lock or non-setting operation may be performed.

In step S21 of mutually comparing and verifying voices stored in the plurality of voice authentication servers 200 and 210, it is preferable to mutually compare voices stored in two different servers 200 and 210, thereby being able to more accurately verify reliability based on whether or not the stored voices match each other.

In addition, in step S28 of setting function lock of the voice terminal, after initial lock setting for all or some of the functions of the terminal 100, when voice is repeatedly mismatched upon re-entry, the user executes the step-by-step response action designated in advance. In step 1, an authentication message may be transmitted to a user terminal, in step 2, a warning message may be transmitted to a terminal set in advance by the user, and in step 3, a location tracking and emergency notification message may be transmitted to a mobile operator or a police station.

That is, after the initial lock setting for all or some of the functions of the terminal, when voice is repeatedly mismatched upon re-entry, the step-by-step response action designated in advance by the user is executed. However, the step-by-step action may be different in the order of each action depending on the selection of the user.

The voice terminal may be applied to various mobile terminals having a mobile or portable form or a stationary form, more specifically, to various mobile terminals such as vehicles, ships, and airplanes in addition to mobile phones, notebooks, tablet computers, computers, headsets, earphones, Bluetooth devices, speakers, and IoT products.

In addition, one or more languages, such as Korean, English, Japanese, and Chinese, may be selected in the a) voice storage step and the b) voice verification step.

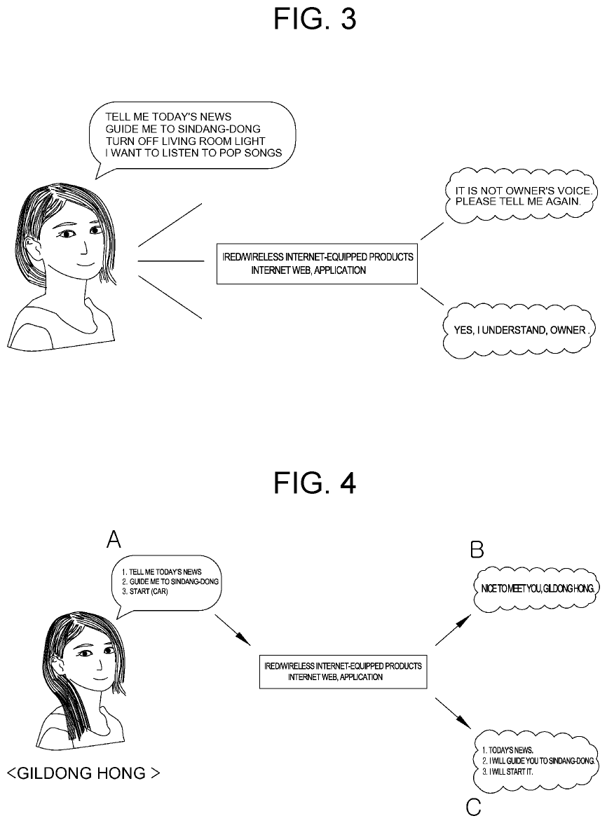

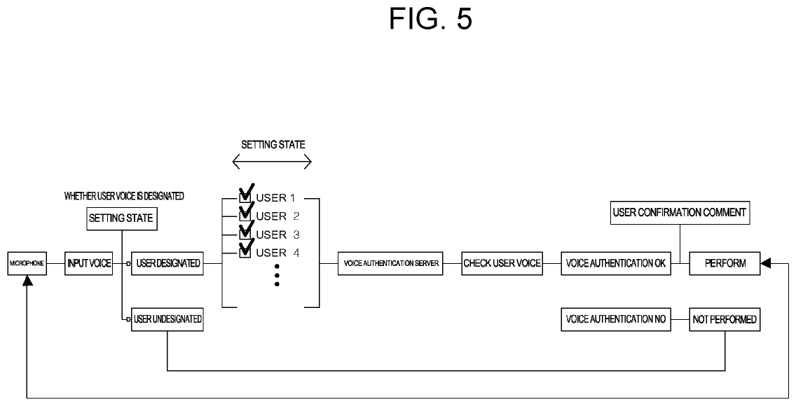

In addition, FIGS. 3 and 4 are diagrams illustrating examples of use of the voice verification and restriction method of the voice terminal according to an embodiment of the present invention, and FIG. 5 is a control block diagram illustrating a command processing step through a voice input by a specific user when one or more users are preset according to an embodiment of the present invention.

As illustrated in the figures, in the case where one or more users are preset, when a specific user gives a command through voice input, voice of the user stored in the voice authentication server is checked. When a preset user matches, a name of the user is called (which may be deleted in actual product implementation), and the command is executed.

In addition, the voice verification and restriction method of the voice terminal is provided and has the following characteristics. A name of the user is called and a command is executed. Alternatively, a command is executed after a procedure of confirming the user, and when the user does not match, a comment about the fact that the user does not match is made, or the operation returns to an initial stage again after a procedure of confirming that the user does not match. When the voice of the user is not set, a command according to the voice of the user is executed without a separate voice authentication procedure.

On the other hand, when the voice of the user stored in the voice authentication server is checked, and the preset voice of the user does not match, a comment about the fact that the user does not match is made, and the operation returns to the initial stage again.

When the voice of the user is not set, a command according to the voice of the user may be executed without a separate voice authentication procedure.

A voice verification and restriction method of a voice terminal according to the present invention configured as described above has an effect of effectively addressing loss or theft of a terminal by setting restrictions for all or some of functions of the terminal and then executing a step-by-step response action designated by a user when voice does not match repeatedly in order to prevent unauthorized use by others and leakage of personal information.

In addition, there is an effect of accurately and safely recognizing and verifying voice of a user by storing voice of the user in a plurality of authentication servers to mutually compare and verify the voice and by storing user voice for each emotional state using a language processing module.

Effects of the present invention are not limited to the effects mentioned above, and other effects not mentioned will be clearly understood by those skilled in the art from the above description.

The embodiments of the present invention described in this specification and the configurations illustrated in the drawings relate to preferred embodiments of the present invention, and do not encompass all the technical spirit of the present invention. Therefore, it should be understood that various equivalents and modifications may be present to substitute therefor at the time of filing. Accordingly, the present invention is not limited to the above-described embodiments, and various modifications can be implemented by anyone with ordinary skill in the art to which the invention pertains without departing from the gist of the invention as claimed in the claims. Further, such changes are within the scope of the claims of the present invention.

What is claimed is:

1. A voice verification and restriction method of a voice terminal, the voice verification and restriction method comprising:
a) voice storage step; and
b) voice verification step, wherein:
the a) voice storage step includes:
inputting and registering voice of a user through a microphone of the voice terminal;
receiving and analyzing the input voice using a language processing module;
transmitting the analyzed voice to a plurality of voice authentication servers to store each voice; and
learning the stored voice using an artificial intelligence (AI) processor,
the b) voice verification step includes:
mutually comparing the input voice with voice stored in at least one server among voices stored in the plurality of voice authentication servers;
performing approval and a voice command when the input voice matches the stored voice; and
a function lock setting step of setting restrictions on all or some of functions of the voice terminal and executing a step-by-step action designated by the user when the input voice does not match the stored voice, and
in the function lock setting step:
when one or more users are preset, and a specific user gives a command through voice input, voices of users stored in the voice authentication servers are checked, and when the preset user matches, a name of the user is called and the command is executed, or the command is executed after a procedure of checking the user;
when the user does not match, a comment about a fact that the user does not match is made, or an operation returns to an initial stage again after a procedure of confirming that the user does not match, and when the voice of the user is not set, a command according to the voice of the user is executed without a separate voice authentication procedure;
after initial lock setting for all or some of the functions of the terminal, when voice is repeatedly mismatched upon re-entry, the user executes a step-by-step response action designated in advance; and
in step 1, an authentication message is transmitted to a user terminal, in step 2, a warning message is transmitted to a terminal set in advance by the user, and in step 3, a location tracking or emergency notification message is transmitted to a mobile operator or a police station.

2. The voice verification and restriction method according to claim 1, wherein the inputting and registering of the voice of the user includes designating and selecting a specific user and inputting and registering the specific user.

3. The voice verification and restriction method according to claim 1, wherein the analyzing of the voice using the language processing module includes classifying the voice of the user according to pronunciation, speed, respiration, rhythm, and vocal features, determining each emotional state, and storing and analyzing the voice for each emotional state.

4. The voice verification and restriction method according to claim 1, wherein the voice terminal has a mobile or portable form or a stationary form and more specifically is applied to any one terminal among vehicles, ships, and airplanes in addition to mobile phones, notebooks, tablet computers, computers, headsets, earphones, Bluetooth devices, speakers, and Internet of Things (IoT) products.

5. The voice verification and restriction method according to claim 1, wherein the a) voice storage step and the b) voice verification step include selecting one or more languages such as Korean, English, Japanese, and Chinese.
